(19) United States
(12) Patent Application Publication
(10) Pub. No.: US 2023/0186116 A1
(43) Pub. Date: Jun. 15, 2023

(54) SYSTEM AND METHOD TO GENERATE A USER INTERFACE PRESENTING A PREDICITION OR EXPLANATION OF INPUT DATA HAVING A TIME SERIES DEPENDENCY OR A GEOSPATIAL DEPENDENCY

(71) Applicant: DataRobot, Inc., Boston, MA (US)

(72) Inventors: Ina Ko, Old Bridge, NJ (US); Borys Kupar, Munich (DE); Yulia Bezhula, Kyiv (UA); Kyrylo Kniazev, Kyiv (UA)

(73) Assignee: DataRobot, Inc., Boston, MA (US)

(21) Appl. No.: 18/078,639

(22) Filed: Dec. 9, 2022

Related U.S. Application Data
(60) Provisional application No. 63/288,251, filed on Dec. 10, 2021.

(51) Int. Cl. G06N 5/022

(52) U.S. Cl. CPC G06N 5/022

(57) ABSTRACT

Aspects of this technical solution can identify, by a second machine learning model receiving as input first features, second features having respective impact metrics that satisfy an impact threshold, the impact threshold indicating that the second features modify various forecast data points, cause a graphical user interface to present the forecast including one or more of the first features having respective first visual properties corresponding to identifiers of respective ones of the first features, cause the graphical user interface to present the forecast including the second features having a second visual property corresponding to an indication that the second features satisfy the impact threshold, and cause the graphical user interface to modify the forecast including the second features to include an explanation portion including metrics of the second features, the metrics corresponding to respective time points of a time dependency relationship.

### CROSS-REFERENCE TO RELATED PATENT APPLICATIONS

This application claims the benefit of priority under 35 U.S.C. § 119 to U.S. Provisional Patent Application Ser. No. 63/288,251, entitled “SYSTEM AND METHOD TO GENERATE A USER INTERFACE PRESENTING A PREDICTION OR EXPLANATION OF INPUT HAVING A TIME SERIES DEPENDENCY OR A GEOSPATIAL DEPENDENCY,” filed Dec. 10, 2021, the contents of such application being hereby incorporated by reference in its entirety and for all purposes as if completely and fully set forth herein.

### TECHNICAL FIELD

The present implementations relate generally to forecasting using machine learning systems, and more particularly to generating a user interface presenting a prediction or explanation of input data having a time series dependency or a geospatial dependency.

### INTRODUCTION

Understanding future behavior of complex systems is increasingly important to maintain efficiency, desired output, and error-free operation of such complex systems. However, it can be challenging to determine behavior of such systems at an increased level of granularity in a reliable and efficient manner. Indeed, it can be difficult to efficiently and effectively identify, with sufficient granularity, factors contributing to the future behavior of such complex systems with temporal or location-based components that cannot be aggregated without specialized processing.

### SUMMARY

Present implementations can include time series prediction explanations. Time series data can include one or more data points having a time dependency relationship with one another. As one example, a time dependency relationship can include a relative relationship with respect to sequence or position. The sequence or position can be absolute or relative, and can vary in magnitude over, for example, the amount of time between two particular data points. Time series predictions can thus indicate a forecast of a future value of a time series. Present implementations can provide functionality to give insight into forecasts compared with actuals over time. Thus, present implementations can generate a user interface allowing users to compare forecasts against actuals, and generate information to indicate the reasoning or operations generating a given forecast. Additionally, users can prepopulate and explore a prediction explanation over time chart of a graphical user interface that can indicate features are most impactful or are driving the prediction value at a particular point in time.

Present implementations can include geospatial support. As one example, a user interface based on a particular dataset can include a location feature, and make a prediction that contains a location type feature. Present implementations can also generate a unique map associated with each location feature in the dataset. As one example, a user interface can expand a location feature row in a manage features or constraints modal, to display a heat map of selectable data for various features that can be provided as input to a machine learning or like model. Thus, a technological solution for generating a user interface presenting a prediction or explanation of input data having a time series dependency or a geospatial dependency is provided.

At least one aspect is directed to a system. The system can generate, by a first machine learning model receiving as input one or more first features can include one or more input data points having a time dependency relationship, a forecast can include one or more forecast data points having the time dependency relationship and positions after the one or more data points. The system can identify, by a second machine learning model receiving as input the first features, one or more second features having respective impact metrics that satisfy an impact threshold, the impact threshold indicating that the second features modify one or more of the forecast data points. The system can cause a graphical user interface to present the forecast can include one or more of the first features having respective first visual properties corresponding to identifiers of respective ones of the first features. The system can cause the graphical user interface to present the forecast can include one or more of the second features having a second visual property corresponding to an indication that the second features satisfy the impact threshold. The system can cause the graphical user interface to modify the forecast can include the second features to include an explanation portion can include one or more metrics of the second features, the metrics corresponding to respective time points of the time dependency relationship.

At least one aspect is directed to a method. The method can include generating, by a first machine learning model receiving as input one or more first features can include one or more input data points having a time dependency relationship, a forecast can include one or more forecast data points having the time dependency relationship and positions after the one or more data points. The method can include identifying, by a second machine learning model receiving as input the first features, one or more second features having respective impact metrics that satisfy an impact threshold, the impact threshold indicating that the second features modify one or more of the forecast data points. The method can include causing a graphical user interface to present the forecast can include one or more of the first features having respective first visual properties corresponding to identifiers of respective ones of the first features. The method can include causing the graphical user interface to present the forecast can include one or more of the second features having a second visual property corresponding to an indication that the second features satisfy the impact threshold. The method can include causing the graphical user interface to modify the forecast can include the second features to include an explanation portion can include one or more metrics of the second features, the metrics corresponding to respective time points of the time dependency relationship.

At least one aspect is directed to a method. The method can include generating, by a graphical user interface, a map can include one or more geospatial indicators, the geospatial indicators can include a feature of training data to a machine learning system. The method can include training, by a machine learning system with input can include geospatial indicators restricted to the subset of the geospatial indicators and in response to a selection at the graphical user interface of at least a subset of the geospatial indicators, a first model to generate one or more forecast values respective to one or more features can include the feature of the geospatial indicators. The method can include generating, by the graphical user interface and based on the first model, a forecast value presentation portion can include a distribution of data points corresponding to the subset of the geospatial indicators.

For example, a method can include generating, by a machine learning system, a forecast based on one or more first features, identifying, by the machine learning system, one or more second features among the first features having an impact satisfying an impact threshold, generating, by a graphical user interface, a presentation having a time component and including one or more of the second features, and modifying, by the graphical user interface, the presentation to include an explanation portion including one or more metrics associated with the second features.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates a system in accordance with present implementations.

FIG. 2 illustrates a first state of a user interface to present at least one of a prediction or an explanation of input data having a time series dependency, in accordance with present implementations.

FIG. 3 illustrates a second state of a user interface to present at least one of a prediction or an explanation of input data having a time series dependency, further to the user interface of

FIG. 4 illustrates a third state of a user interface to present at least one of a prediction or an explanation of input data having a time series dependency, in accordance with present implementations.

FIG. 5 illustrates a fourth state of a user interface to present at least one of a prediction or an explanation of input data having a time series dependency, further to the user interface of FIG. 4.

FIG. 6 illustrates a first state of a user interface to present a prediction based on input data having a geospatial dependency, in accordance with present implementations.

FIG. 7 illustrates a second state of a user interface to present a prediction based on input data having a geospatial dependency, in accordance with present implementations.

FIG. 8 illustrates a third state of a user interface to present a prediction based on input data having a geospatial dependency, in accordance with present implementations.

FIG. 9 illustrates a fourth state of a user interface to present a prediction based on input data having a geospatial dependency, in accordance with present implementations.

FIG. 10 illustrates a fifth state of a user interface to present a prediction based on input data having a geospatial dependency, in accordance with present implementations.

FIG. 11 illustrates an example method of presenting a forecast with a time dependency, in accordance with present implementations.

FIG. 12 illustrates an example method of presenting a forecast with a geospatial feature, in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

Time series prediction explanations can advantageously compare forecast data at a particular time with actual data or new data at a particular time, can provide insight on prediction explanations over time, can toggle a date range to see specific time periods, can select different time unit resolutions and automatically populate or repopulate a graphical user interface accordingly, can explore positive and negative trends, and can highlight prediction explanations of interest with real-time responsive changes to particular features or other components of a chart presented or presentable at a graphical user interface.

Present implementation can include geospatial processing for machine learning applications, and can advantageously generate both batch and one-off predictions using an app builder, and generate a unique map associated with each location feature in the dataset. As one example, a user interface can expand a location feature row in a manage features or constraints modal, to display a heat map of selectable data for various features that can be provided as input to a machine learning or like model.

For example, a method can include modifying, by the graphical user interface, the presentation to provide an indication of one or more of the second features. For example, the indication includes a change in color or brightness of one or more of the second features. For example, the metrics correspond to an impact associated with a particular feature of the second features. For example, the impact includes at least one of a direction of impact, a magnitude of impact, or a type of impact. For example, a method can include generating, by a graphical user interface, a map including one or more geospatial indicators, the geospatial indicators including training data to a machine learning system, receiving, at the graphical user interface, a selection of at least a subset of the geospatial indicators, and generating, by the machine learning system, a machine learning model trained with input including the subset and excluding data points outside of the selection.

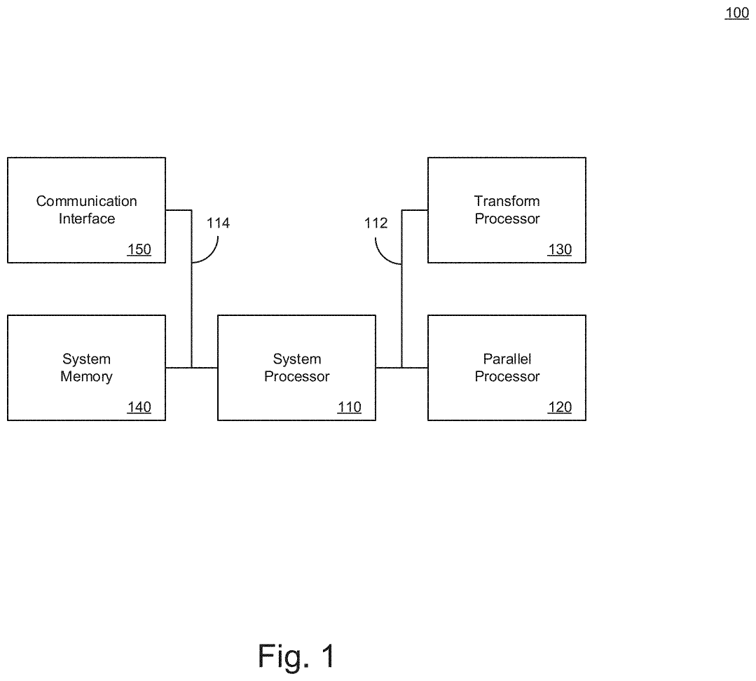

FIG. 1 illustrates a system in accordance with present implementations. As illustrated by way of example in FIG. 1, an example processing system 100 includes a system processor 110, a parallel processor 120, a transform processor 130, a system memory 140, and a communication interface 150. In some implementations, at least one of the example processing system 100 or the system processor 110 includes a processor bus 112 and a system bus 114.

The system processor 110 can execute one or more instructions. The instructions can be associated with at least one of the system memory 140 or the communication interface 150. The system processor 110 can include an electronic processor, an integrated circuit, or the like including one or more of digital logic, analog logic, digital sensors, analog sensors, communication buses, volatile memory, nonvolatile memory, and the like. The system processor 110 can include but is not limited to, at least one microcontroller unit (MCU), microprocessor unit (VIPU), central processing unit (CPU), graphics processing unit (GPU), physics processing unit (PPU), embedded controller (EC), or the like. In some implementations, the system processor 110 can include a memory operable to store or storing one or more instructions for operating components of the system processor 110 and operating components operably coupled to the system processor 110. The one or more instructions can include at least one of firmware, software, hardware, operating systems, embedded operating systems, or the like.

The processor bus 112 can communicate one or more instructions, signals, conditions, states, or the like between one and more of the system processor 110, the parallel processor 120, and the transform processor 130. The processor bus 112 can include one or more digital, analog, or like communication channels, lines, traces, or the like. It is to be understood that any electrical, electronic, or like devices, or components associated with the system bus 114 can also be associated with, integrated with, integrable with, supplemented by, complemented by, or the like, the system processor 110 or any component thereof.

The system bus 114 can communicate one or more instructions, signals, conditions, states, or the like between one or more of the system processor 110, the system memory 140, and the communication interface 150. The system bus 114 can include one or more digital, analog, or like communication channels, lines, traces, or the like. It is to be understood that any electrical, electronic, or like devices, or components associated with the system bus 114 can also be associated with, integrated with, integrable with, supplemented by, complemented by, or the like, the system processor 110 or any component thereof.

The parallel processor 120 can execute one or more instructions concurrently, simultaneously, or the like. The parallel processor 120 can execute one or more instructions in a parallelized order in accordance with one or more parallelized instruction parameters. Parallelized instruction parameters can include one or more sets, groups, ranges, types, or the like, associated with various instructions. The parallel processor 120 can include one or more execution cores variously associated with various instructions. The parallel processor 120 can include one or more execution cores variously associated with various instruction types or the like. The parallel processor 120 can include an electronic processor, an integrated circuit, or the like including one or more of digital logic, analog logic, communication buses, volatile memory, nonvolatile memory, and the like. The parallel processor 120 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the parallel processor 120 can also be associated with, integrated with, integrable with, supplemented by, complemented by, or the like, the system processor 110 or any component thereof.

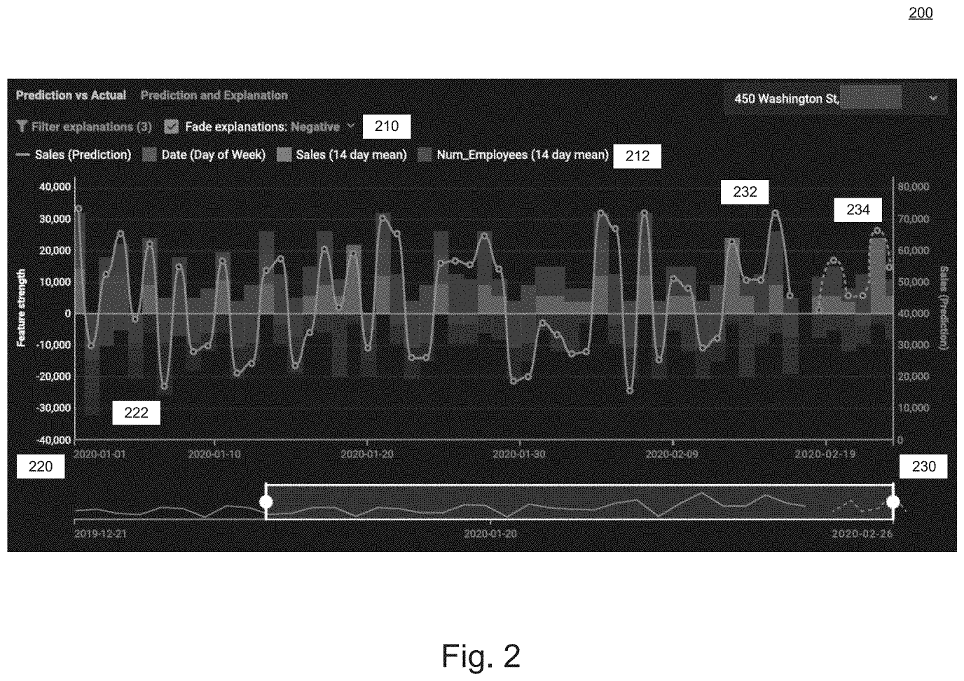

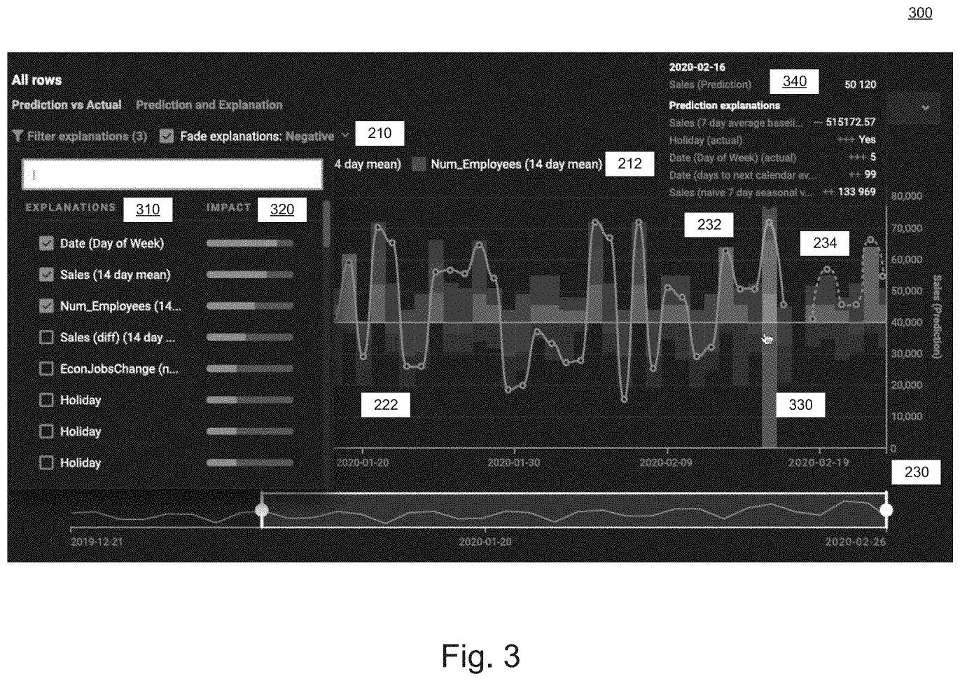

Various cores of the parallel processor 120 can be associated with one or more parallelizable operations in accordance with one or more metrics, engines, models, and the like, of the example computing system of FIG. 3. As one example, parallelizable operations include processing portions of an image, video, waveform, audio waveform, processor thread, one or more layers of a learning model, one or more metrics of a learning model, one or more models of a learning system, and the like. A predetermined number or predetermined set of one or more particular cores of the parallel processor 120 can be associated exclusively with one or more distinct sets of corresponding metrics, engines, models, and the like, of one or more of FIGS. 2-10. Thus, the parallel processor 120 can parallelize execution across one or more metrics, engines, models, and the like, of one or more of FIGS. 2-10. Similarly, a predetermined number or predetermined set of one or more particular cores of the parallel processor 120 can be associated collectively with corresponding metrics, engines, models, and the like, of one or more of FIGS. 2-10. As one example, a first plurality of cores of the parallel processor can be assigned to, associated with, configured to, fabricated to, or the like, execute one engine of one or more of FIGS. 2-10. In this example, a second plurality of cores of the parallel processor can also be assigned to, associated with, configured to, fabricated to, or the like, execute another engine of one or more of FIGS. 2-10. Thus, the parallel processor 120 can parallelize execution within one or more metrics, engines, models, and the like, of one or more of FIGS. 2-10.

The transform processor 130 can execute one or more instructions associated with one or more predetermined transformation processes. As one example, transformation processes include Fourier transforms, matrix operations, calculus operations, combinatoric operations, trigonometric operations, geometric operations, encoding operations, decoding operations, compression operations, decompression operations, image processing operations, audio processing operations, and the like. The transform processor 130 can execute one or more transformation processes in accordance with one or more transformation instruction parameters. Transformation instruction parameters can include one or more instructions associating the transform processor 130 with one or more predetermined transformation processes. The transform processor 130 can include one or more transformation processes. The transform processor 130 can include a plurality of transform processors 130 variously associated with various predetermined transformation processes. The transform processor 130 can include a plurality of transformation processing cores each associated with, configured to execute, fabricated to execute, or the like, a predetermined transformation process. The transform processor 130 can include an electronic processor, an integrated circuit, or the like including one or more of digital logic, analog logic, communication buses, volatile memory, nonvolatile memory, and the like. The transform processor 130 can include but is not limited to, at least one graphics processing unit (GPU), physics processing unit (PPU), embedded controller (EC), gate array, programmable gate array (PGA), field-programmable gate array (FPGA), application-specific integrated circuit (ASIC), or the like. It is to be understood that any electrical, electronic, or like devices, or components associated with the transform processor 130 can also be associated with, integrated with, integrable with, supplemented by, complemented by, or the like, the system processor 110 or any component thereof.

The transform processor 130 can be associated with one or more predetermined transform processes in accordance with one or more metrics, engines, models, and the like, of one or more of FIGS. 2-10. A predetermined transform process of the transform processor 130 can be associated with one or more corresponding metrics, engines, models, and the like, of one or more of FIGS. 2-10. As one example, the transform processor 130 can be assigned to, associated with, configured to, fabricated to, or the like, execute one matrix operation associated with one or more engines, metrics, models, or the like, of one or more of FIGS. 2-10. As another example, the transform processor 130 can alternatively be assigned to, associated with, configured to, fabricated to, or the like, execute another matrix operation associated with one or more engines, metrics, models, or the like, of one or more of FIGS. 2-10. Thus, the transform processor 130 can centralize, optimize, coordinate, or the like, execution of a transform process across one or more metrics, engines, models, and the like, of one or more of FIGS. 2-10. In some implementations, the transform processor is fabricated to, configured to, or the like, execute a particular transform process with at least one of a minimum physical logic footprint, logic complexity, heat expenditure, heat generation, power consumption, or the like, with respect to one or more metrics, engines, models, and the like, of one or more of FIGS. 2-10.

The system memory 140 can store data associated with the example processing system 100. The system memory 140 can include one or more hardware memory devices for storing binary data, digital data, or the like. The system memory 140 include one or more electrical components, electronic components, programmable electronic components, reprogrammable electronic components, integrated circuits, semiconductor devices, flip flops, arithmetic units, or the like. The system memory 140 can include at least one of a non-volatile memory device, a solid-state memory device, a flash memory device, or a NAND memory device. The system memory 140 can include one or more addressable memory regions disposed on one or more physical memory arrays. As one example, a physical memory array can include a NAND gate array disposed on a particular semiconductor device, integrated circuit device, or printed circuit board device.

The communication interface 150 can communicatively couple the system processor 110 to an external device. An external device includes but is not limited to a smartphone, mobile device, wearable mobile device, tablet computer, desktop computer, laptop computer, cloud server, local server, and the like. The communication interface 150 can communicate one or more instructions, signals, conditions, states, or the like between one or more of the system processor 110 and the external device. The communication interface 150 includes one or more digital, analog, or like communication channels, lines, traces, or the like. As one example, the communication interface 150 can include at least one serial or parallel communication line among multiple communication lines of a communication interface. The communication interface 150 can include one or more wireless communication devices, systems, protocols, interfaces, or the like. The communication interface 150 can include one or more logical or electronic devices including but not limited to integrated circuits, logic gates, flip flops, gate arrays, programmable gate arrays, and the like. The communication interface 150 can include one or more telecommunication devices including but not limited to antennas, transceivers, packetizers, wired interface ports, and the like. It is to be understood that any electrical, electronic, or like devices, or components associated with the communication interface 150 can also be associated with, integrated with, integrable with, replaced by, supplemented by, complemented by, or the like, the system processor 110 or any component thereof.

FIG. 2 illustrates a first state of a user interface to present at least one of a prediction or an explanation of input data having a time series dependency, in accordance with present implementations. As illustrated by way of example in FIG. 2, a user interface 200 can include an explanation affordance 210, a feature impact legend 212, a feature strength axis 220, a plurality of features 222 presented according to feature strength, a prediction axis 230, a past values curve 232, and a forecast curve 234. The explanation affordance 210 can include a toggle, list, or the like, to modify a presentation of at least one of the features 222. As one example, setting fade explanations to negative can reduce brightness of all features presented with negative magnitude. As another example, setting fade explanations to positive can reduce brightness of all features presented with positive magnitude. The feature impact legend 212 can indicate one or more of the features 222 that have highest impact on one or more of the past values curve 232 and the forecast curve 234 at a particular time. The features 222 can be displayed according to a magnitude of their impact on a particular value of the past values curve 232 or the forecast curve 234 at a particular time.

FIG. 3 illustrates a second state of a user interface to present at least one of a prediction or an explanation of input data having a time series dependency, further to the user interface of FIG. 2. As illustrated by way of example in FIG. 3, a user interface 300 can include the explanation affordance 210, the feature impact legend 212, the features 222, the prediction axis 230, the past values curve 232, the forecast curve 234, a plurality of explanation selection affordances 310, a plurality of impact indicators 320, a highlight cursor 330, and an explanation element 340. The explanation selection affordances 310 can include one or more check box affordances or the like each associated with a particular feature. The impact indicators 320 can each indicate a magnitude of impact of the corresponding feature associated with the explanation selection affordances 310. The highlight cursor 330 can indicate by, for example, a color or brightness change, a portion of the user interface associated with the explanation element 340. The highlight cursor 330 can include, for example, a bar extending vertically across a portion of the user interface and can be aligned with or enclose a particular time or times. The explanation element 340 can include explanations related to particular feature, and can include impact or other metrics associated with the time or times associated with the highlight cursor 330.

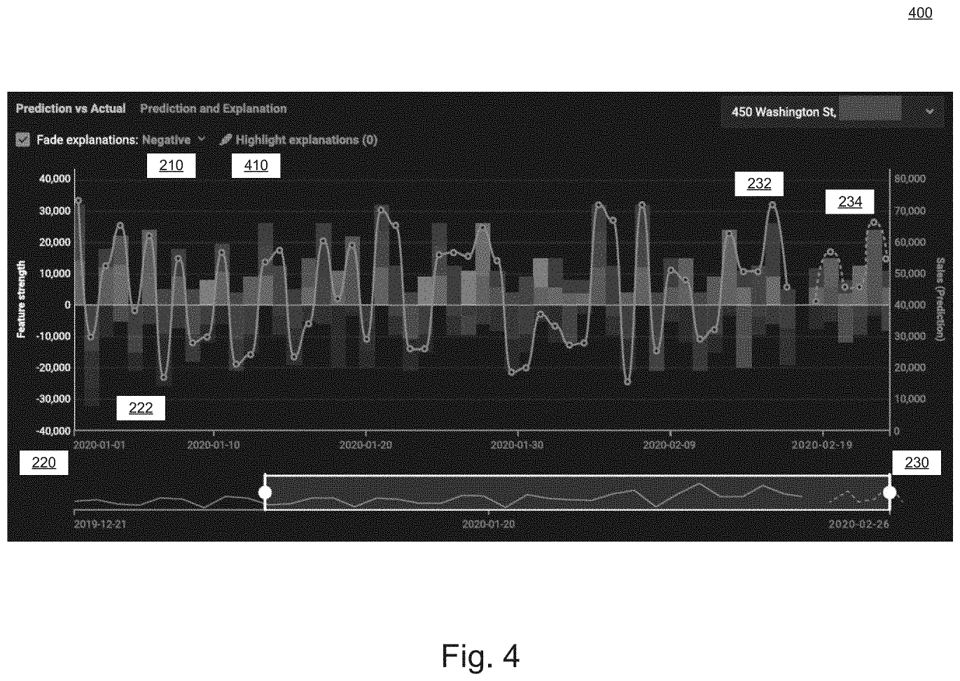

FIG. 4 illustrates a third state of a user interface to present at least one of a prediction or an explanation of input data having a time series dependency, in accordance with present implementations. As illustrated by way of example in FIG. 4 a user interface 400 can include the explanation affordance 210, the feature impact legend 212, the feature strength axis 220, the features 222, the prediction axis 230, the past values curve 232, the forecast curve 234, and a highlight explanations affordance 410 in a first state. As one example, the highlight explanations affordance 410 in the first state can indicate zero highlighted features. Correspondingly, none of the features 222 can be highlighted.

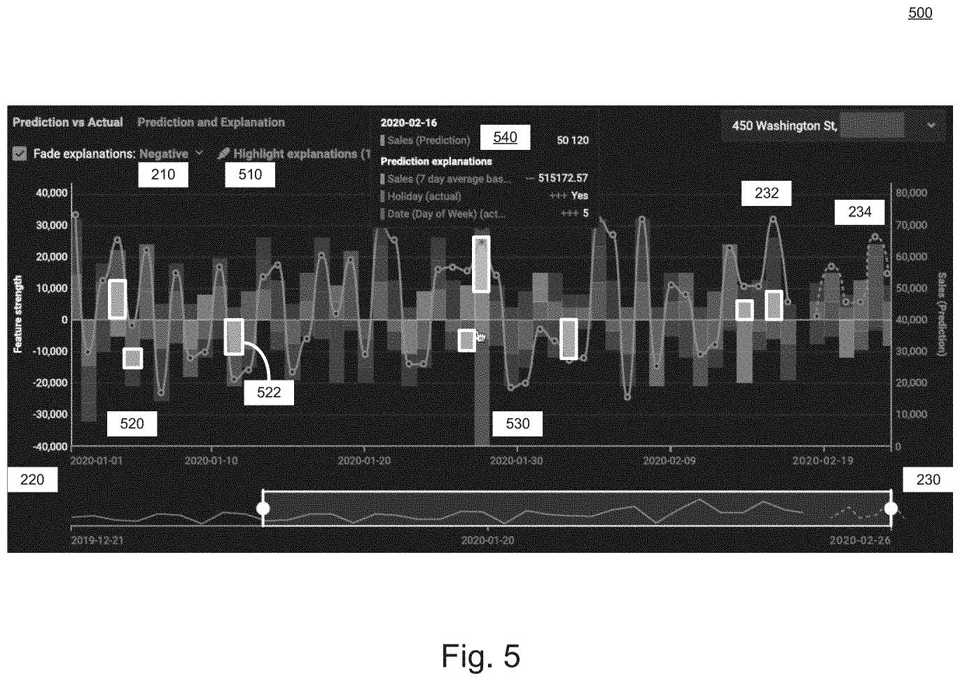

FIG. 5 illustrates a fourth state of a user interface to present at least one of a prediction or an explanation of input data having a time series dependency, further to the user interface of FIG. 4. As illustrated by way of example in FIG. 5, a user interface 500 can include the explanation affordance 210, the feature impact legend 212, the feature strength axis 220, prediction axis 230, the past values curve 232, the forecast curve 234, a highlight explanations affordance 510 in a second state, a plurality of features 520, a highlighted features 522 among the features 520, a highlight cursor 530, and an explanation element 540. The features 520 can correspond at least partially to the features 222. The highlight cursor 530 can correspond at least partially to the highlight cursor 330. The explanation element 540 can correspond at least partially to the explanation element 340. As one example, the highlight explanations affordance 510 in the second state can indicate one highlighted feature. Correspondingly, the user interface can highlight feature 522, one of the features 520. As one example, the user interface can highlight each instance of the feature 522 over the time period visible in the user interface.

For example, the system can cause the graphical user interface to present the forecast can include an impact indicator corresponding to a second feature of the second features and that indicates a magnitude of impact of the second feature associated with the explanation portion. For example, the system can cause the graphical user interface to present one or more portions of a selected feature of the second features, the portions of the selected feature having the second visual property. For example, the system can cause the graphical user interface to present one or more portions of a selected feature of the second features at one or more time points having a time dependency relationship and corresponding to the forecast. For example, the system can include the first visual properties corresponding to a first brightness, and the second visual property corresponding to a second brightness. For example, the system can include the first visual properties corresponding to a first color, and the second visual property corresponding to a second color. For example, the system can cause the graphical user interface to present a highlight cursor can include a bar a particular time or times. For example, the impact metrics can include at least one of a direction of impact, a magnitude of impact, or a type of impact.

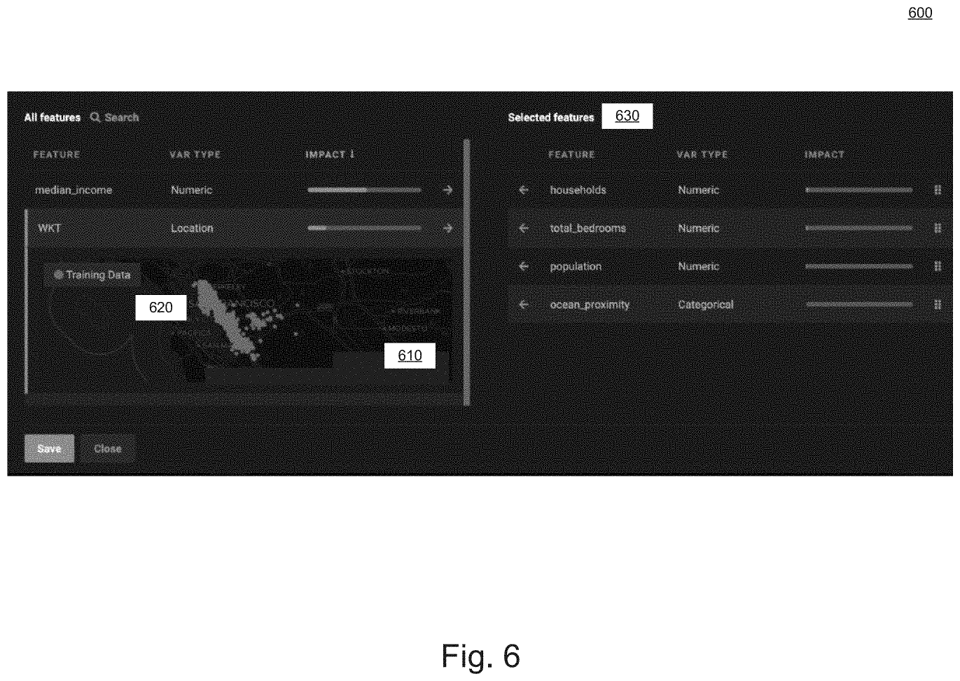

FIG. 6 illustrates a first state of a user interface to present a prediction based on input data having a geospatial dependency, in accordance with present implementations. As illustrated by way of example in FIG. 6, a user interface 600 can include a map presentation portion 610, a plurality of training data presentation elements 620, and selected feature presentation portion 630.

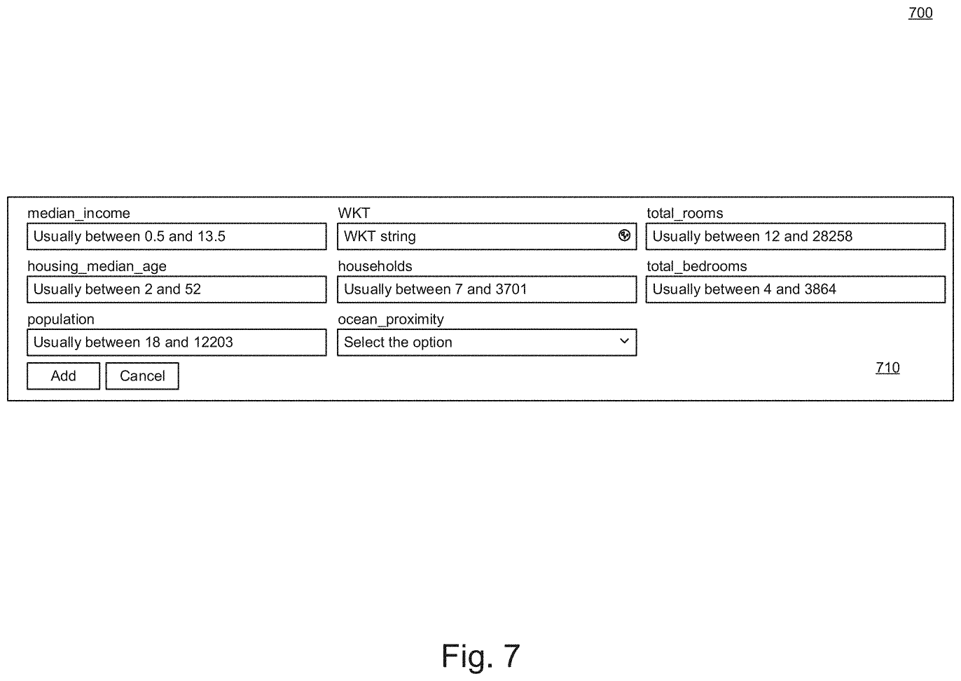

FIG. 7 illustrates a second state of a user interface to present a prediction based on input data having a geospatial dependency, in accordance with present implementations. As illustrated by way of example in FIG. 7, a user interface 700 can include metrics 710. Metrics 710 can include one or more features that can be input to a machine learning model with geospatial capability in accordance with present implementations.

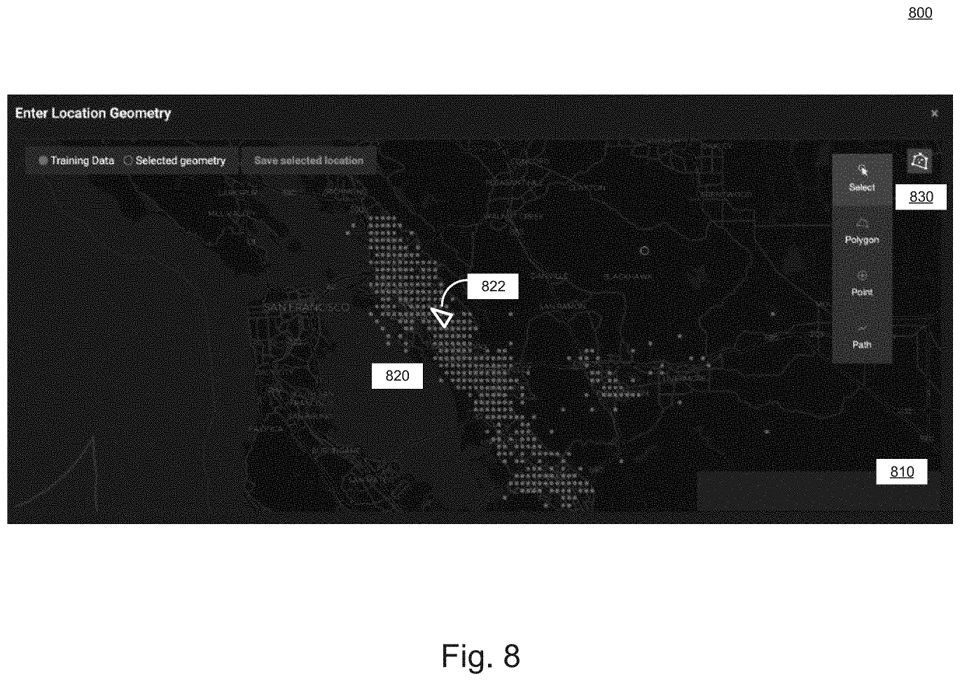

FIG. 8 illustrates a third state of a user interface to present a prediction based on input data having a geospatial dependency, in accordance with present implementations. As illustrated by way of example in FIG. 8, a user interface 800 can include a map presentation portion 810, a plurality of training data presentation elements 820, a geospatial geometry portion 822, and a geospatial control affordance 830. The geospatial control affordance 830 can generate at least one shape, line, point, polygon, path, or the like, to generate the geospatial geometry portion 822. The geospatial geometry portion 822 can indicate a group of the training data presentation elements 820, and can indicate a group of training data elements associated with the training data presentation elements 820. As one example, the geospatial geometry portion 822 can identify a subset of training data elements corresponding only to the training data presentation elements 820 within the geospatial geometry portion 822. Thus, present implementations can advantageously provide a user interface to modify, with a high degree of flexibility and granularity, input to a machine learning system in accordance with a geospatial feature.

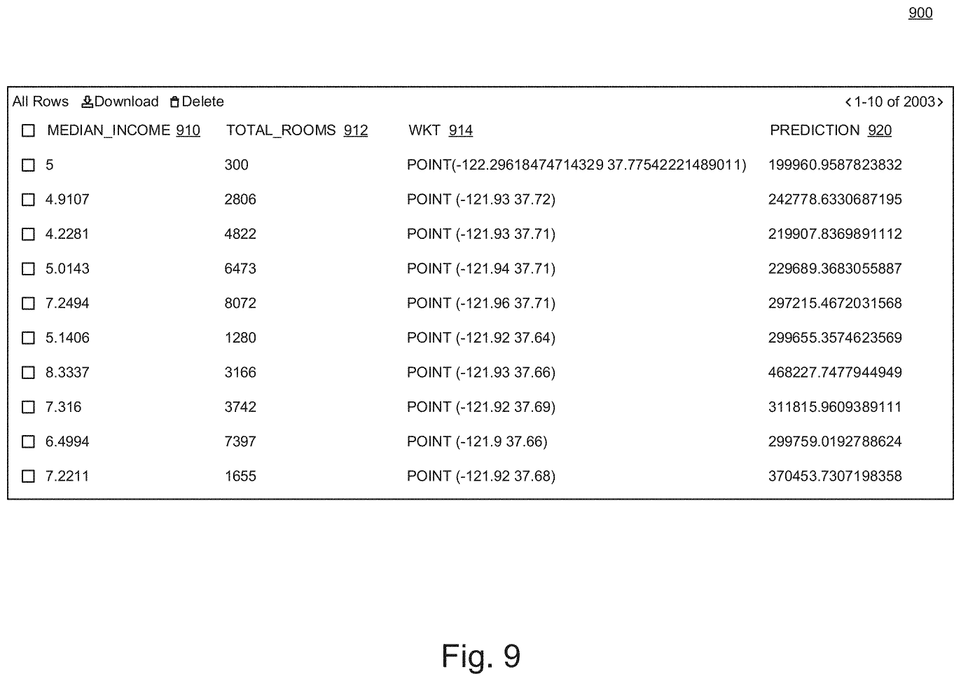

FIG. 9 illustrates a fourth state of a user interface to present a prediction based on input data having a geospatial dependency, in accordance with present implementations. As illustrated by way of example in FIG. 9, a user interface 900 can include a presentation including a first features 910, a second feature 912, a geospatial feature 914, and a prediction output 920.

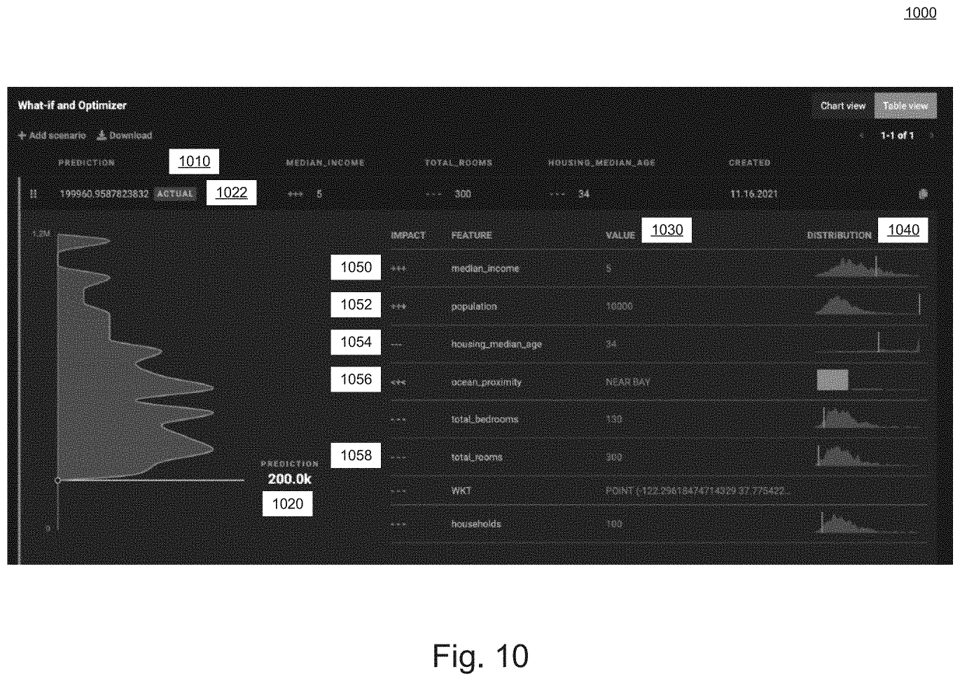

FIG. 10 illustrates a fifth state of a user interface to present a prediction based on input data having a geospatial dependency, in accordance with present implementations. As illustrated by way of example in FIG. 10, a user interface 1000 can include a presentation 1010 associated with a particular prediction or forecast output for a particular input data point. The presentation 1010 can include a forecast value presentation portion 1020, an actual value presentation portion 1022, a value presentation portion 1030, a distribution presentation portion 1040, and a plurality of impact indicators 1050, 1052, 1054, 1056 and 1058. The forecast value presentation portion 1020 can include a chart indicating a relationship between the prediction and one or more additional factors. The factors can include a comparison to similar input data points, or input data points having one or more common features with a data point associated with the prediction. The value presentation portion 1020 can indicate particular values of a particular feature. The feature can vary based on data point, and can be associated with a high impact or highest impact feature for the data point, for example. The value presentation portion 1020 can be associated with a feature identifier portion that provides an explanation of the high impact feature in the form of the name of the feature, for example. The distribution presentation portion 1040 can indicate a position of the value of a high impact feature within a distribution of a plurality of values of the feature for a plurality of data points. Thus, the distribution presentation portion 1040 can indicate the relative value of the feature with respect to its entire cohort of ingested values. The impact indicators 1050, 1052, 1054, 1056 and 1058 can each respectively indicate a characteristic of an impact associated with a particular feature. As one example, impact indicators 1050, 1052, 1054, 1056 and 1058 can each respectively correspond to indicators having values that indicate one or more of a direction of impact (e.g., positive or negative), a magnitude of impact (e.g., relative or absolute magnitude), or a type of impact (e.g., linear, nonlinear). Thus, the impact indicators 1050, 1052, 1054, 1056 and 1058 can advantageously indicate multiple aspects of impact of a feature in an at-a-glance structure.

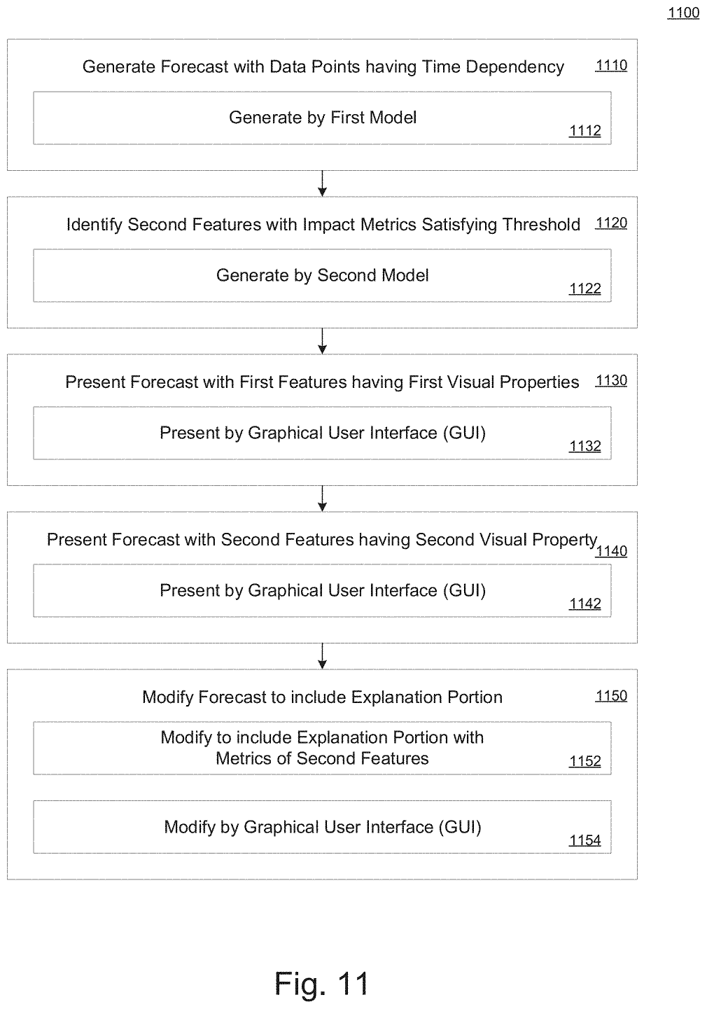

FIG. 11 depicts an example method of presenting a forecast with a time dependency, in accordance with present implementations. At least one of one or more components of the system 100 or one or more components of the user interfaces 200-1000 can perform method 1100.

At 1110, the method 1100 can generate a forecast including one or more forecast data points having a time dependency relationship. At 1112, the method 1100 can generate a forecast including one or more forecast data points having a time dependency relationship by a first machine learning model. For example, the method 1100 can include causing the graphical user interface to present one or more portions of a selected feature of the second features at one or more time points having a time dependency relationship and corresponding to the forecast.

At 1120, the method 1100 can identify one or more second features having respective impact metrics that satisfy an impact threshold. For example, the method 1100 can include causing the graphical user interface to present the forecast that can include an impact indicator corresponding to a second feature of the second features and that indicates a magnitude of impact of the second feature associated with the explanation portion. At 1122, the method 1100 can identify one or more second features having respective impact metrics that satisfy an impact threshold by a second machine learning model. For example, the impact metrics can include at least one of a direction of impact, a magnitude of impact, or a type of impact.

The first machine learning model can be different from the second machine learning model. The first machine learning model can be trained with different data than the second machine learning model. The first machine learning model can be configured or trained to receive different types of input or provide different types of output compared to the second machine learning model. For example, the first machine learning model can be configured to generate a forecast based on input including one or more features. The second machine learning model can be configured to generate one or more metrics based on input including one or more of the first model and one or more of the features. The second machine learning model can be configured to compare one or more of the features to the forecast to determine one or more impact metrics. Each impact metric can correspond to the result of a comparison between one or more selected features from among the features and the forecast. The impact metrics can indicate a degree or magnitude of correlation between the selected feature and the forecast with respect to particular time points or over a time range.

At 1130, the method 1100 can present a forecast including first features having first visual properties. At 1132, the method 1100 can cause a graphical user interface to present a forecast including first features having first visual properties.

At 1140, the method 1100 can present a forecast including second features having at least one second visual property. At 1142, the method 1100 can cause the graphical user interface to present the forecast including second features having at least one second visual property. For example, the method 1100 can include causing the graphical user interface to present one or more portions of a selected feature of the second features, the portions of the selected feature having the second visual property. For example, the method 1100 can include the first visual properties corresponding to a first brightness, and the second visual property corresponding to a second brightness. For example, the method 1100 can include the first visual properties corresponding to a first color, and the second visual property corresponding to a second color.

At 1150, the method 1100 can modify a forecast to include an explanation portion. At 1152, the method 1100 can modify a forecast to include an explanation portion including metrics of one or more second features. At 1154, the method 1100 can cause the graphical user interface to modify a forecast to include an explanation portion. For example, the method 1100 can cause the graphical user interface to present a highlight cursor can include a bar a particular time or times.

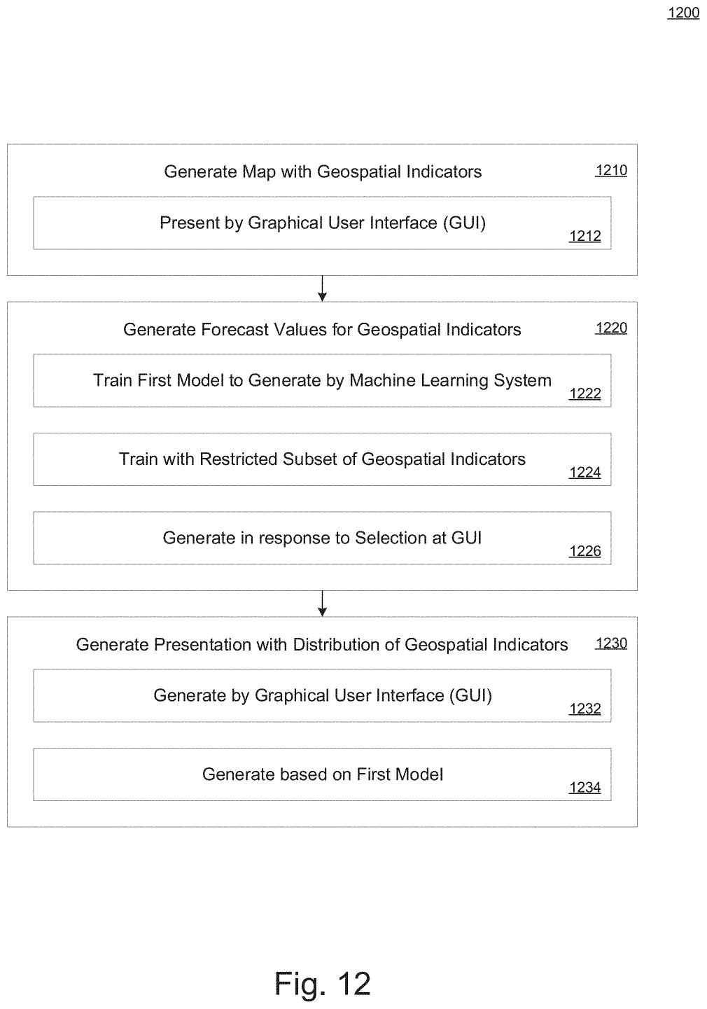

FIG. 12 depicts an example method of presenting a forecast with a geospatial feature, in accordance with present implementations. At least one of one or more components of the system 100 or one or more components of the user interfaces 200-1000 can perform method 1200.

At 1210, the method 1200 can generate a map including geospatial indicators comprising at least one feature. At 1212, the method 1200 can generate a map including geospatial indicators comprising at least one feature by a graphical user interface. For example, the method can include training, by a machine learning system, the features in response to a selection at the graphical user interface of at least a subset of the geospatial indicators, a second model to generate an impact metric corresponding to one or more of the features and the first model.

At 1220, the method 1200 can generate forecast values for one or more geospatial indicators. At 1222, the method 1200 can train a first model to generate forecast values for one or more geospatial indicators by a machine learning system. At 1224, the method 1200 can train with geospatial indicators restricted to subset of geospatial indicators. At 1226, the method 1200 can train a first model to generate forecast values for one or more geospatial indicators in response to a selection at a graphical user interface of a subset.

At 1230, the method 1200 can generate a forecast value presentation portion including a distribution of subset of geospatial indicators. For example, the method 1200 can include generating, by the graphical user interface and based on the second model, one or more impact indicators respectively corresponding to one or more of the features. At 1232, the method 1200 can generate a forecast value presentation by a graphical user interface. At 1234, the method 1200 can generate a forecast value presentation portion including a distribution of subset of geospatial indicators based on the first model. For example, the method can include generating, by the graphical user interface and based on the first model, a distribution presentation portion that can include a plurality of distributions of data points respectively corresponding to one or more of the features.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

He foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A system comprising:
one or more processors to:
generate, by a first machine learning model receiving as input one or more first features including one or more input data points having a time dependency relationship, a forecast including one or more forecast data points having the time dependency relationship and positions after the one or more data points;
identify, by a second machine learning model receiving as input the first features, one or more second features having respective impact metrics that satisfy an impact threshold, the impact threshold indicating that the second features modify one or more of the forecast data points;
cause a graphical user interface to present the forecast including one or more of the first features having respective first visual properties corresponding to identifiers of respective ones of the first features;
cause the graphical user interface to present the forecast including one or more of the second features having a second visual property corresponding to an indication that the second features satisfy the impact threshold; and
cause the graphical user interface to modify the forecast including the second features to include an explanation portion including one or more metrics of the second features, the metrics corresponding to respective time points of the time dependency relationship.

2. The system of claim 1, the processors to:
cause the graphical user interface to present the forecast including an impact indicator corresponding to a second feature of the second features and that indicates a magnitude of impact of the second feature associated with the explanation portion.

3. The system of claim 1, the processors to:
cause the graphical user interface to present one or more portions of a selected feature of the second features, the portions of the selected feature having the second visual property.

4. The system of claim 1, the processors to:
cause the graphical user interface to present one or more portions of a selected feature of the second features at one or more time points having a time dependency relationship and corresponding to the forecast.

5. The system of claim 1, the first visual properties corresponding to a first brightness, and the second visual property corresponding to a second brightness.

6. The system of claim 1, the first visual properties corresponding to a first color, and the second visual property corresponding to a second color.

7. The system of claim 1, the processors to:
cause the graphical user interface to present a highlight cursor including a bar a particular time or times.

8. The system of claim 1, the impact metrics comprise at least one of a direction of impact, a magnitude of impact, or a type of impact.

9. A method comprising:
generating, by a first machine learning model receiving as input one or more first features including one or more input data points having a time dependency relationship, a forecast including one or more forecast data points having the time dependency relationship and positions after the one or more data points;
identifying, by a second machine learning model receiving as input the first features, one or more second features having respective impact metrics that satisfy an impact threshold, the impact threshold indicating that the second features modify one or more of the forecast data points;
causing a graphical user interface to present the forecast including one or more of the first features having respective first visual properties corresponding to identifiers of respective ones of the first features;
causing the graphical user interface to present the forecast including one or more of the second features having a second visual property corresponding to an indication that the second features satisfy the impact threshold; and
causing the graphical user interface to modify the forecast including the second features to include an explanation portion including one or more metrics of the second features, the metrics corresponding to respective time points of the time dependency relationship.

10. The method of claim 9, further comprising:
causing the graphical user interface to present the forecast including an impact indicator corresponding to a second feature of the second features and that indicates a magnitude of impact of the second feature associated with the explanation portion.

11. The method of claim 9, further comprising:
causing the graphical user interface to present one or more portions of a selected feature of the second features, the portions of the selected feature having the second visual property.

12. The method of claim 9, further comprising:
causing the graphical user interface to present one or more portions of a selected feature of the second features at one or more time points having a time dependency relationship and corresponding to the forecast.

13. The method of claim 9, the first visual properties corresponding to a first brightness, and the second visual property corresponding to a second brightness.

14. The method of claim 9, the first visual properties corresponding to a first color, and the second visual property corresponding to a second color.

15. The method of claim 9, the processors to:
cause the graphical user interface to present a highlight cursor including a bar a particular time or times.

16. The method of claim 9, the impact metrics comprise at least one of a direction of impact, a magnitude of impact, or a type of impact.

17. A method comprising:
generating, by a graphical user interface, a map including one or more geospatial indicators, the geospatial indicators comprising a feature of training data to a machine learning system;
training, by a machine learning system with input including geospatial indicators restricted to the subset of the geospatial indicators and in response to a selection at the graphical user interface of at least a subset of the geospatial indicators, a first model to generate one or more forecast values respective to one or more features including the feature of the geospatial indicators; and
generating, by the graphical user interface and based on the first model, a forecast value presentation portion including a distribution of data points corresponding to the subset of the geospatial indicators.

18. The method of claim 17, further comprising:
training, by a machine learning system with input including the features in response to a selection at the graphical user interface of at least a subset of the geospatial indicators, a second model to generate an impact metric corresponding to one or more of the features and the first model.

19. The method of claim 18, further comprising:
generating, by the graphical user interface and based on the second model, one or more impact indicators respectively corresponding to one or more of the features.

20. The method of claim 17, further comprising:
generating, by the graphical user interface and based on the first model, a distribution presentation portion including a plurality of distributions of data points respectively corresponding to one or more of the features.
